(19) United States
(12) Patent Application Publication
(10) Pub. No.: US 2024/0355205 A1
(43) Pub. Date: Oct. 24, 2024

(54) System for warning drivers about accident-dangerous sections of the road (SWDDR)

(71) Applicant: Aleksei KUKISHEV, Palo Alto, CA (US)

(72) Inventor: Aleksei KUKISHEV, Palo Alto, CA (US)

(21) Appl. No.: 18/429,553

(22) Filed: Feb. 1, 2024

Related U.S. Application Data
(60) Provisional application No. 63/460,338, filed on Apr. 19, 2023.

(51) Int. Cl. G08G 1/16; G08G 1/01

(52) U.S. Cl. CPC G08G 1/164; G08G 1/0129; G08G 1/0137

(57) ABSTRACT

An apparatus and method are provided, which allow vehicle drivers to be efficiently warned of approaching accident-prone road sections. For this purpose, geographical coordinates of a moving vehicle of a driver are compared with geographical coordinates of boundaries of each of one or more pre-stored accident-prone road sections within a geographical area of interest. As a result of said comparison, an approaching accident-prone road section is determined for the moving vehicle. When the distance between the moving vehicle and the approaching accident-prone road section is equal to a threshold distance, a warning signal is generated and outputted to the driver. The warning signal comprises information about the approaching accident-prone road section that is defined based on accident-related data for each traffic accident occurred on the approaching accident-prone road section during a time period of interest.

### TECHNICAL FIELD

The present disclosure relates to the field of road safety. In particular, the present disclosure relates to an apparatus and method for warning a driver about an accident-prone road section, as well as to a corresponding computer program product.

### BACKGROUND OF THE INVENTION

There is a significant number of places on the road, so-called accident-prone road sections, where road conditions require drivers to pay extra attention and strictly follow traffic rules. Lack of increased attention of drivers on the accident-prone road sections or even minor violations of traffic rules, which do not create danger on normal road sections, can lead to severe road accidents on these sections.

At the same time, as experience in combating accidents on the accident-prone road sections shows, warning drivers of the potential accident-related danger of a given road section and, optionally, the consequences of the accidents that previously occurred on the road section could lead to concentration of drivers' attention on the road section and strict compliance by drivers with traffic rules thereon, which contributes to the prevention of accidents involving the drivers on the section of road.

### SUMMARY OF THE INVENTION

This summary is provided to introduce a selection of concepts in a simplified form that are further described below in the detailed description. This summary is not intended to identify key features of the present disclosure, nor is it intended to be used to limit the scope of the present disclosure.

It is an objective of the present disclosure to provide a technical solution that allows vehicle drivers to be efficiently warned of approaching accident-prone road sections.

The objective above is achieved by the features of the independent claims in the appended claims. Further embodiments and examples are apparent from the dependent claims, the detailed description, and the accompanying drawings.

According to a first aspect, an apparatus for warning a driver about an accident-prone road section is provided. The apparatus comprises a memory unit, a processing unit, and an output unit. The memory unit is configured to store: (i) geographical coordinates of boundaries of each of at least one accident-prone road section within a geographical area of interest, each of the at least one accident-prone road section being a road section where at least two traffic accidents have occurred during a time period of interest; and (ii) accident-related data for each of the at least two traffic accidents occurred on each of the at least one accident-prone road section during the time period of interest. The processing unit is coupled to the memory unit and configured to operate as follows. At first, the processing unit receives geographical coordinates of a moving vehicle of the driver. Then, the processing unit uses the geographical coordinates of the moving vehicle and the geographical coordinates of boundaries of each of the at least one accident-prone road section to determine an approaching accident-prone road section from among the at least one accident-prone road section. When a distance between the moving vehicle and the approaching accident-prong road section is equal to a threshold distance, the processing unit generates a warning signal for the driver, which comprises information about the approaching accident-prone road section that is defined based on the accident-related data for each of the at least two traffic accidents occurred on the approaching accident-prone road section for the time period of interest. The output unit is coupled to the processing unit and configured to output the warning signal to the driver. The apparatus thus configured may facilitate better concentration of drivers on accident-prone road sections, thereby contributing to improved road safety.

In one exemplary embodiment of the first aspect, the accident-related data comprises at least one of: (i) a total number of traffic accidents occurred on each of the at least one accident-prone road section for the time period of interest; (ii) a type of each of the at least two traffic accidents occurred on each of the at least one accident-prone road section; (iii) a cause of each of the at least two traffic accidents occurred on each of the at least one accident-prone road section; (iv) consequences of each of the at least two traffic accidents occurred on each of the at least one accident-prone road section, and (v) road conditions observed during each of the at least two traffic accidents occurred on each of the at least one accident-prone road section. By using such accident-related data, it is possible to properly generate the warning signal for the driver.

In one exemplary embodiment of the first aspect, the type of each of the at least two traffic accidents occurred on each of the at least one accident-prone road section comprises at least one of: (i) a collision with one or more pedestrians; (ii) a collision with one or more animals; (iii) a collision with one or more obstacles; (iv) a collision between two or more vehicles; and (v) a rollover of one or more vehicles. Such information about the type of each accident may be further used when generating the warning signal to draw the driver's attention to the most potential danger on the road.

In one exemplary embodiment of the first aspect, the cause of each of the at least two traffic accidents occurred on each of the at least one accident-prone road section comprises at least one of: (i) speeding; (ii) driver inattention (e.g., due to driver fatigue and/or falling asleep at the wheel); (iii) a pedestrian crossing a road in an inappropriate place; (iv) a violation of rules of crossing an intersection; (v) driving under a prohibited traffic light sign; (vi) an animal running out onto a road; and (vii) a driver failed to control a vehicle. Such information about the cause of each accident may be also used when generating the warning signal to draw the driver's attention to the most potential danger on the road.

In one exemplary embodiment of the first aspect, the consequences of each of the at least two traffic accidents occurred on each of the at least one accident-prone road section comprises at least one of: (i) a number of fatalities; (ii) a number of injured people; and (iii) a level of property damage. Such information about the consequences each accident may be further used to determine whether the approaching accident-prone road section relates to the one with severe consequences or not, and properly generate the warning signal based on the results of said determination. For example, the approaching accident-prone road section may be considered as the one with the severe consequences if, during the time period of interest (e.g., one previous calendar year), there were two or more accidents that caused bodily injury and/or death of the victim (fatality); in this case, the warning signal may additionally indicate that the approaching accident-prone road section is of the “severe consequences” type to motivate the driver to be even more careful on the approaching accident-prone road section. At the same time, if no bodily injury and/or death of the victims has taken place on the approaching accident-prone road section during the time period of interest, the approaching accident-prone road section may be considered as the one without any severe consequences, and the warning signal may simply indicate the presence of the approaching accident-prone road section. Thus, by using the information about the consequences of each traffic accident, different types of the warning signals may be generated, each of which may be beneficial in certain use scenarios.

In one exemplary embodiment of the first aspect, the road conditions observed during each of the at least two traffic accidents occurred on each of the at least one accident-prone road section comprise at least one of: (i) a type of an atmospheric phenomenon; (ii) a condition of a road surface; (iii) an ambient temperature; (iv) a time of day; (v) a week day; and (vi) lighting conditions. The road conditions observed during each accident may be compared with those currently observed on the approaching accident-prone road section, whereupon the results of said comparison may be further used to properly generate the warning signal.

In one exemplary embodiment of the first aspect, if the consequences each of the at least two traffic accidents occurred on the approaching accident-prone road section during the time period of interest comprise the number of fatalities and/or the number of injured people, the processing unit is configured to generate the warning signal such that the warning signal further comprises the number of fatalities and/or the number of injured people (e.g., the number of fatalities and/or the number of injured people). This specific information about the (harmful and fatal to health) consequences of each traffic accident may additionally cause the driver to be extremely careful on the approaching accident-prone road section.

In one exemplary embodiment of the first aspect, the processing unit is further configured to find, among the causes of the at least two traffic accidents occurred on the approaching accident-prone road section during the time period of interest, a common cause that has led to a maximum number of traffic accidents on the approaching accident-prone road section during the time period of interest. In this embodiment, the warning signal further indicates the common cause to the driver. The indication of the common cause may additionally motivate the driver to be extremely careful on the approaching accident-prone road section.

In one exemplary embodiment of the first aspect, the processing unit is further configured to receive information about current road conditions observed on the approaching accident-prone road section and calculate a degree of traffic accident probability for the driver based on the current road conditions and the road conditions observed during each of the at least two traffic accidents occurred on the approaching accident-prone road section for the time period of interest. In this embodiment, the output unit is further configured to output the degree of traffic accident probability to the driver. The degree of traffic accident probability may further motivate the driver to be extremely careful on the approaching accident-prone road section.

According to a second aspect, a method for warning a driver about an accident-prone road section is provided. The method starts with the step of storing geographical coordinates of boundaries of each of at least one accident-prone road section within a geographical area of interest. Each of the at least one accident-prone road section is a road section where at least two traffic accidents have occurred during a time period of interest. Then, the method proceeds to the step of storing accident-related data for each of the at least two traffic accidents occurred on each of the at least one accident-prone road section during the time period of interest. Next, the method goes on to the step of receiving geographical coordinates of a moving vehicle of the driver. Further, the method proceeds to the step of using the geographical coordinates of the moving vehicle and the geographical coordinates of boundaries of each of the at least one accident-prone road section to determine an approaching accident-prone road section from among the at least one accident-prone road section. When a distance between the moving vehicle and the approaching accident-prong road section is equal to a threshold distance, the method goes on to the step of generating a warning signal for the driver. The warning signal comprises information about the approaching accident-prone road section that is defined based on the accident-related data for each of the at least two traffic accidents occurred on the approaching accident-prone road section for the time period of interest. Subsequently, the method proceeds to the step of outputting the warning signal to the driver. By doing so, it is possible to facilitate better concentration of drivers on accident-prone road sections, thereby contributing to improved road safety.

In one exemplary embodiment of the second aspect, the accident-related data comprises at least one of: (i) a total number of traffic accidents occurred on each of the at least one accident-prone road section for the time period of interest; (ii) a type of each of the at least two traffic accidents occurred on each of the at least one accident-prone road section; (iii) a cause of each of the at least two traffic accidents occurred on each of the at least one accident-prone road section; (iv) consequences of each of the at least two traffic accidents occurred on each of the at least one accident-prone road section, and (v) road conditions observed during each of the at least two traffic accidents occurred on each of the at least one accident-prone road section. By using such accident-related data, it is possible to properly generate the warning signal for the driver.

In one exemplary embodiment of the second aspect, the type of each of the at least two traffic accidents occurred on each of the at least one accident-prone road section comprises at least one of: (i) a collision with one or more pedestrians; (ii) a collision with one or more animals; (iii) a collision with one or more obstacles; (iv) a collision between two or more vehicles; and (v) a rollover of one or more vehicles. Such information about the type of each traffic accident may be further used when generating the warning signal to draw the driver's attention to the most potential danger on the road.

In one exemplary embodiment of the second aspect, the cause of each of the at least two traffic accidents occurred on each of the at least one accident-prone road section comprises at least one of: (i) speeding; (ii) driver inattention (e.g., due to driver fatigue and/or falling asleep at the wheel); (iii) a pedestrian crossing a road in an inappropriate place; (iv) a violation of rules of crossing an intersection; (v) driving under a prohibited traffic light sign; (vi) an animal running out onto a road; and (vii) a driver failed to control a vehicle. Such information about the cause of each traffic accident may be also used when generating the warning signal to draw the driver's attention to the most potential danger on the road.

In one exemplary embodiment of the second aspect, the consequences of each of the at least two traffic accidents occurred on each of the at least one accident-prone road section comprises at least one of: (i) a number of fatalities; (ii) a number of injured people; and (iii) a level of property damage. Such information about the consequences of each accident may be further used to determine whether the approaching accident-prone road section relates to the one with severe consequences or not, and properly generate the warning signal based on the results of said determination. For example, the approaching accident-prone road section may be considered as the one with the severe consequences if, during the time period of interest (e.g., one previous calendar year), there were two or more accidents that caused bodily injury and/or death of the victims; in this case, the warning signal may additionally indicate that the approaching accident-prone road section is of the “severe consequences” type to motivate the driver to be even more careful on the approaching accident-prone road section. At the same time, if no bodily injury and/or death of the victims has taken place on the approaching accident-prone road section during the time period of interest, the approaching accident-prone road section may be considered as the one without any severe consequences, and the warning signal may simply indicate the presence of the approaching accident-prone road section. Thus, by using the information about the consequences of each accident, different types of the warning signals may be generated, each of which may be beneficial in certain use scenarios.

In one exemplary embodiment of the second aspect, the road conditions observed during each of the at least two traffic accidents occurred on each of the at least one accident-prone road section comprise at least one of: (i) a type of an atmospheric phenomenon; (ii) a condition of a road surface; (iii) an ambient temperature; (iv) a time of day; (v) a week day; and (vi) lighting conditions. The road conditions observed during each accident may be compared with those currently observed on the approaching accident-prone road section, whereupon the results of said comparison may be further used to properly generate the warning signal.

In one exemplary embodiment of the second aspect, if the consequences each of the at least two traffic accidents occurred on the approaching accident-prone road section during the time period of interest comprise the number of fatalities and/or the number of injured people, the warning signal is generated such that the warning signal further comprises the number of fatalities and/or the number of injured people. This specific information about the (harmful and fatal to health) consequences of each traffic accident may additionally cause the driver to be extremely careful on the approaching accident-prone road section.

In one exemplary embodiment of the second aspect, the method further comprises the step of finding, among the causes of the at least two traffic accidents occurred on the approaching accident-prone road section during the time period of interest, a common cause that has led to a maximum number of traffic accidents on the approaching accident-prone road section during the time period of interest. In this embodiment, the warning signal further indicates the common cause to the driver. The indication of the common cause may additionally cause the driver to be extremely careful on the approaching accident-prone road section.

In one exemplary embodiment of the second aspect, the method further comprises the steps of receiving information about current road conditions observed on the approaching accident-prone road section and calculating a degree of traffic accident probability for the driver based on the current road conditions and the road conditions observed during each of the at least two traffic accidents occurred on the approaching accident-prone road section for the time period of interest. The degree of traffic accident probability is further outputted to the driver. The degree of traffic accident probability may further motivate the driver to be extremely careful on the approaching accident-prone road section.

According to a third aspect, a computer program product is provided. The computer program product comprises a computer-readable storage medium that stores a computer code. Being executed by at least one processor, the computer code causes the at least one processor to perform the method according to the second aspect. By using such a computer program product, it is possible to simplify the implementation of the method according to the second aspect in any computing device, like the apparatus according to the first aspect.

Other features and advantages of the present disclosure will be apparent upon reading the following detailed description and reviewing the accompanying drawings.

### BRIEF DESCRIPTION OF DRAWINGS

The present disclosure is explained below with reference to the accompanying drawings in which:

FIG. 1 shows a general block diagram of an apparatus for warning a driver about an accident-prone road section according to one exemplary embodiment;

FIG. 2 shows a flowchart of a method for operating the apparatus of FIG. 1 according to one exemplary embodiment; and

FIG. 3 shows a sketch of a geographical area comprising multiple accident-prone road sections according to one exemplary embodiment.

### DETAILED DESCRIPTION OF THE INVENTION

Various embodiments of the present disclosure are further described in more detail with reference to the accompanying drawings. However, the present disclosure can be embodied in many other forms and should not be construed as limited to any certain structure or function discussed in the following description. In contrast, these embodiments are provided to make the description of the present disclosure detailed and complete.

According to the detailed description, it will be apparent to the ones skilled in the art that the scope of the present disclosure encompasses any embodiment thereof, which is disclosed herein, irrespective of whether this embodiment is implemented independently or in concert with any other embodiment of the present disclosure. For example, the apparatus and method disclosed herein can be implemented in practice by using any numbers of the embodiments provided herein. Furthermore, it should be understood that any embodiment of the present disclosure can be implemented using one or more of the elements presented in the appended claims.

As used in the exemplary embodiments disclosed herein, an accident-prone road section may refer to a road section where two or more traffic (or road) accidents occurred during a time period of interest. For example, the accident-prone road section may be a highway, street, avenue, boulevard, village road, alley, estate road, access road, etc., or any portion of these and other road types. Moreover, the accident-prone road section may be an intersection of two or more roads. The length of each accident-prone road section may be determined, for example, based on data on the location of the accident-prone road section (e.g., within a city, town, on a highway, etc.), the number and spacing of traffic accidents occurred on the accident-prone road section during the time period of interest, and/or consequences of the traffic accidents. A traffic accident may refer to an event that occurs when a vehicle collides with another vehicle, pedestrian, animal, road debris, or any other moving or stationary obstacle or obstruction, such as a tree, pole or building. As for the time period of interest, it may be for example, one or more calendar days, weeks, months, years, decades, etc.

The exemplary embodiments disclosed herein relate to a technical solution that allows vehicle drivers to be efficiently warned of approaching accident-prone road sections. For this purpose, geographical coordinates of a moving vehicle of a driver are compared with geographical coordinates of boundaries of each of one or more pre-stored accident-prone road sections within a geographical area of interest (e.g., a particular part of a town, a country, a region, or the world). As a result of said comparison, an approaching accident-prone road section is determined for the moving vehicle. When the distance between the moving vehicle and the approaching accident-prone road section is equal to a threshold distance, a warning signal is generated and outputted to the driver. The warning signal comprises information about the approaching accident-prone road section that is defined based on accident-related data for each traffic accident occurred on the approaching accident-prone road section during a time period of interest.

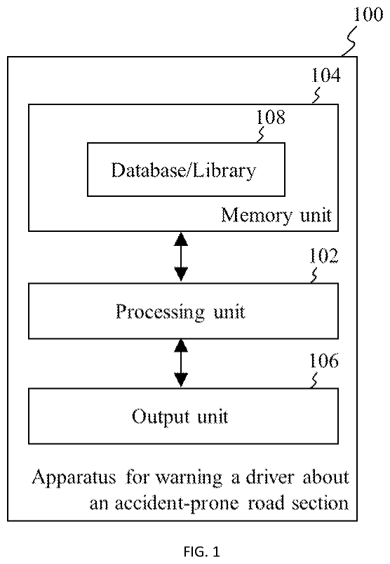

FIG. 1 shows a general block diagram of an apparatus 100 for warning a driver about an accident-prone road section according to one exemplary embodiment. It should be noted that the apparatus 100 may be implemented based on hardware, software, or their combination. For example, the apparatus 100 may be integrated or embedded in a vehicle as a part of an on-board computer, an individual vehicular component, a driver-assistance subsystem, etc., or it may be implemented as an individual apparatus connectable to the vehicle by means of wireless communications. Such an individual apparatus may refer to a mobile user equipment (UE), such as a mobile station, mobile terminal, mobile subscriber unit, mobile phone, cellular phone, smart phone, cordless phone, personal digital assistant (PDA), laptop, etc. The individual apparatus may also refer to a server station, server computer, etc.

In a preferred embodiment, the apparatus 100 is implemented as a mobile application for a mobile UE that is configured to operate without any technical connection with the vehicle itself. Such a mobile application may be stored in a remote server and drivers may access the remote server using their mobile UEs to download and install the mobile application on the mobile UE.

As shown in FIG. 1, the apparatus 100 comprises a processing unit 102, a memory unit 104, and an output unit 106. The memory unit 104 stores a database or library 108 comprising information about boundaries of each accident-prone road section within a geographical area of interest and associated accident-related data for each traffic accident occurred on each accident-prone road section during a time period of interest. It should be noted that the number, arrangement, and interconnection of the units constituting the apparatus 100, which are shown in FIG. 1, are not intended to be any limitation of the present disclosure, but merely used to provide a general idea of how the units may be implemented within the apparatus 100. For example, the processing unit 102 may be replaced with several processing units (each performing a certain function), as well as the memory unit 104 may be replaced with several removable and/or fixed storage devices, depending on particular applications. Furthermore, in some embodiments, the processing unit 102 may be configured to perform different operations required for data reception and transmission, such, for example, as signal modulation/demodulation, encoding/decoding, etc. Alternatively, the apparatus 100 may further comprise an individual transceiving unit which can be configured to perform the required operations for data reception and transmission based on commands from the processing unit 102. In general, each of the units of the apparatus 100 may be implemented as a hardware component, a software component, or their combination.

Being a hardware component, the processing unit 102 may be implemented as a CPU, general-purpose processor, single-purpose processor, microcontroller, microprocessor, application specific integrated circuit (ASIC), field programmable gate array (FPGA), digital signal processor (DSP), complex programmable logic device, etc. It should be also noted that the processing unit 102 may be implemented as any combination of one or more of the aforesaid. As an example, the processing unit 102 may be a combination of two or more microprocessors.

Being a hardware component, the memory unit 104 may be implemented as a classical nonvolatile or volatile memory used in the modern electronic computing machines. As an example, the nonvolatile memory may include Read-Only Memory (ROM), ferroelectric Random-Access Memory (RAM), Programmable ROM (PROM), Electrically Erasable PROM (EEPROM), solid state drive (SSD), flash memory, magnetic disk storage (such as hard drives and magnetic tapes), optical disc storage (such as CD, DVD and Blu-ray discs), etc. As for the volatile memory, examples thereof include Dynamic RAM, Synchronous DRAM (SDRAM), Double Data Rate SDRAM (DDR SDRAM), Static RAM, etc.

Being a hardware component, the output unit 106 may be implemented as a monitor or display (e.g., LED display). In the above-mentioned preferred embodiment with the mobile UE, the output unit 106 may be represented by the display of the mobile UE itself. Additionally, the output unit 106 may be provided with one or more light indicators (e.g., LED indicators, panels, etc.).

The geographical coordinates of the boundaries of each accident-prone road section, which are contained in the library or database 108, may include, but not limited to, the latitude and longitude of the starting point of a specific accident-prone road section and the latitude and longitude of the end point of that accident-prone road section. The accident-related data also stored in the library or database 108 may comprise one or more of the following information kinds for each accident-prone road section:
a total number of traffic accidents occurred on that road section during the time period of interest;
data about a type (or nature) of each traffic accident occurred on that road section during the time period of interest (e.g., a collision with one or more pedestrians, a collision with one or more animals, a collision with one or more obstacles or obstructions, a collision between two or more vehicles, a rollover of one or more vehicles, etc.);
data about a cause of each traffic accident occurred on that road section during the time period of interest (e.g., speeding, driver inattention, a pedestrian or animal running out onto a road, a violation of rules of crossing an intersection, driving under a prohibited traffic light sign, a driver failed to control a vehicle, etc.);
consequences of each traffic accident occurred on that road section during the time period of interest (e.g., a number of fatalities, a number of injured people, a level of property damage, any combination thereof, etc.); and
road conditions observed during each traffic accident occurred on that road section (e.g., a type of an atmospheric phenomenon (rain, snow, fog, etc.), a condition of a road surface (slippery, wet, dry, snow-covered, etc.), an ambient temperature, a time of day (morning, day, evening, night), a week day, lighting conditions (daylight, dark, presence of artificial lighting, etc.), and the like).

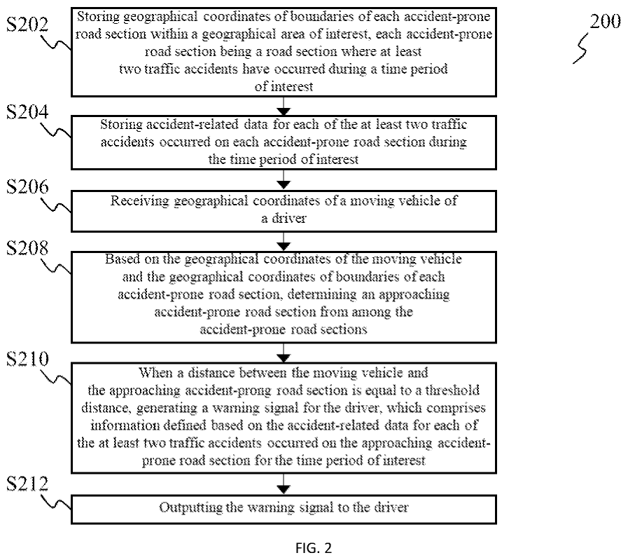

FIG. 2 shows a flowchart of a method 200 for operating the apparatus 100 according to one exemplary embodiment. The method 200 starts with a step S202, in which the processing unit 102 stores the geographical coordinates of the boundaries of each accident-prone road section within the geographical area of interest into the memory unit 104. As noted above, each accident-prone road section is a road section where two or more traffic accidents have occurred during a time period of interest (e.g., one previous calendar year). Then, the method 200 proceeds to a step S204, in which the processing unit 102 stores the accident-related data for each of the traffic accidents occurred on each accident-prone road section during the time period of interest into the memory unit 104. It should be noted that the steps S202 and S204 may be combined into a single step, and the processing unit 102 may perform that step by accessing a remote server and downloading these data to the memory unit 104. Alternatively, the apparatus 100 may be provided with the library or database 108 by default, and the remote server may notify the apparatus 100 to download one or more updates to the library or database 108, if any (e.g., a new accident-prone road section is determined within the geographical area of interest).

After the steps S202 and S204 are performed (i.e., the required library or database 108 is stored into the memory unit 104), the method 200 goes on to a step S206, in which the processing unit 102 receives geographical coordinates of a moving vehicle of the driver. For example, the geographical coordinates of the moving vehicle may be provided to the processing unit 102 by a navigation system that may be either a built-in system of the vehicle and/or a remote system monitoring the movement of the vehicle on the road. If the apparatus 100 is part of a mobile UE (e.g., smartphone) and present inside the moving vehicle, the built-in navigation system of the mobile UE may be used in the step S206. Alternatively or additionally, the built-in navigation system of the vehicle itself may be also used in the step S206.

Further, the method 200 proceeds to a step S208, in which the processing unit 102 uses the geographical coordinates of the moving vehicle and the geographical coordinates of boundaries of each accident-prone road section to determine an approaching accident-prone road section from among one or more accident-prone road sections present within the geographical area of interest. When the distance between the moving vehicle and the approaching accident-prong road section (i.e., its starting point) is equal to a threshold distance, the method 200 goes on to a step S210, in which the processing unit 102 generates a warning signal for the driver. The threshold distance may be user-defined (e.g., defined by a system operator, road authorities, city administration, etc.) and/or depend on the accident-related data for the approaching accident-prone road section. For example, the threshold distance may be set to 1,000 feet to the starting point of the approaching accident-prone road section. As for the warning signal, it comprises information about the approaching accident-prone road section that is defined based on the accident-related data for each of two or more traffic accidents occurred on the approaching accident-prone road section for the time period of interest.

As an example, the processing unit 102 may provide various types of warning signals depending on whether the traffic accidents occurred on the approaching accident-prone road section have resulted in serious (or severe) consequences for victims of the traffic accidents. In this case, the severe consequences may imply a bodily injury and/or a fatal outcome. If the severe consequences have taken place on the approaching accident-prone road section, then the processing unit 102 may generate the warning signal as the following text and/or voice message: “Ahead is an accident-prone road section where severe consequences with fatalities were observed during the previous calendar year”, or “Ahead is an accident-prone road section where severe consequences: in the previous calendar year, there were (number of fatalities) and (number of injuries) on this road section”. In the contrary case (i.e., with no severe consequence observed during the time period of interest), the warning signal may comprise the following information: “There is an approaching accident-prone road section ahead”.

In one embodiment, the processing unit 102 may further be configured to find, among the causes of the traffic accidents occurred on the approaching accident-prone road section during the time period of interest, a common cause that has led to a maximum number of traffic accidents on the approaching accident-prone road section during the time period of interest. In this embodiment, the processing unit 102 may generate the warning signal such that it further indicates the common cause to the driver. For example, if on the approaching accident-prone road section all traffic accidents have previously occurred mainly because of exceeding the maximum permitted speed, the warning signal may further comprise the following information: “Special attention to not exceeding the maximum permitted speed”, or “Do not exceed the maximum permitted speed”.

Referring back to FIG. 2, the method 200 ends up with a step S212, in which the processing unit 102 instructs the output unit 106 to output the warning signal generated in the step S210 to the driver.

In one other embodiment, the method 200 may comprise additional steps, in which the processing unit 102 receives information about current road conditions observed on the approaching accident-prone road section and calculates a degree of traffic accident probability for the driver based on the current road conditions and the road conditions observed during each of the traffic accidents occurred on the approaching accident-prone road section for the time period of interest. In other words, the processing unit 102 may compare the information about the current road conditions with the information about the road conditions under which the traffic accidents have occurred previously on the approaching accident-prone road section and, based on the results of said comparison, calculate the degree of traffic accident probability as the degree of coincidence of the road conditions existing now and at the time of the traffic accidents. The degree of traffic accident probability may be set to “high”, “medium”, or “low”, or it may be set to an approximate percentage or equivalent value (e.g., 80% or 0.8). The degree of traffic accident probability is further outputted to the driver together with the warning signal.

Let us now give one non-restrictive example of how the degree of traffic accident probability may be calculated by the processing unit 102. At first, let us assume that there is an approaching accident-prone road section for a moving car, for which the accident-related data comprises information about 10 traffic accidents occurred during a previous calendar year. Out of these 10 traffic accidents, 6 traffic accidents occurred at night when it was snowing, 3 traffic accidents occurred during the day when it was raining, and 1 traffic accident occurred during the day when it was foggy. If the driver of the moving car is going to drive through this road section at night when it is snowing, i.e., in the road conditions in which more than 50% of the traffic accidents have occurred, the apparatus 100 may define the degree of traffic accident probability on this road section as “high”. However, if the driver is going to drive through this road section during the daytime in the absence of snow, rain, and fog, i.e., in the road conditions in which no traffic accident has occurred on this road section, the apparatus 100 may define the degree of traffic accident probability on this road section as “low”.

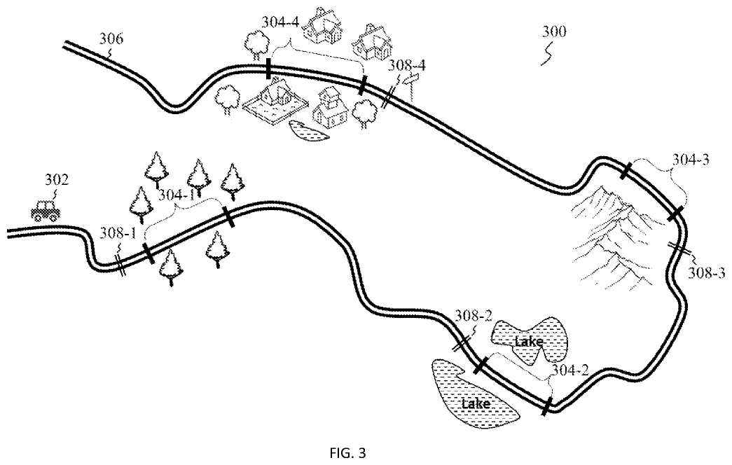

FIG. 3 shows a sketch of a geographical area 300 comprising multiple accident-prone road sections according to one exemplary embodiment. In this embodiment, it is assumed that a driver of a moving car 302 is informed about accident-prone road sections 304-1, 304-2, 304-3, and 304-4 along a traffic route 306 within the geographical area 300. It is assumed that the apparatus 100 is implemented as a mobile application installed on a mobile phone (not shown) belonging to the driver and located in the car 302. As the car 302 moves along the traffic route 306, the driver is warned of the accident-prone road sections 304-1, 304-2, 304-3, and 304-4 in a sequential order, i.e., one by one. The warning signal for each of the accident-prone road sections 304-1, 304-2, 304-3, and 304-4 is generated and outputted to the driver when the car 302 passes through reference points 308-1, 308-2, 308-3, and 308-4, respectively. In other words, the reference points 308-1, 308-2, 308-3, and 308-4 define threshold distances to the accident-prone road sections 304-1, 304-2, 304-3, and 304-4. It should be noted that the threshold distance for each of the accident-prone road sections 304-1, 304-2, 304-3, and 304-4 may be the same or different.

As shown in FIG. 3, the first accident-prone road section 304-1 corresponds to a forest area, and traffic accidents occurred thereon might be caused by animals running out onto the road. The second accident-prone road section 304-2 corresponds to an area of lakes, and traffic accidents occurred thereon might be caused by frequent foggy conditions. The third accident-prone road section 304-3 lies in a mountain area, and traffic accidents occurred thereon might be caused by that the road section 304-3 is too curvy or serpentine, whereupon drivers might fail to control their cars in a previous time period of interest. The fourth accident-prone road section 304-4 corresponds to an urban area, and traffic accidents occurred thereon might be caused by pedestrian crossing the road in inappropriate places.

Given the above assumptions, the driver of the car 302 may receive the following (voice and/or visual, and/or textual) messages from the apparatus 100 for each of the accident-prone road sections 304-1, 304-2, 304-3, and 304-4:
for the road section 304-1: “You are approaching an accident-prone road section in (number of meters). Special attention should be drawn to animals running out onto the road”;
for the road section 304-2: “You are approaching an accident-prone road section in (number of meters). Special attention should be drawn to the road due to foggy visibility”;
for the road section 304-3: “You are approaching an accident-prone road section in (number of meters). Special attention should be drawn to the curved nature of the road section”; and
for the road section 304-4: “You are approaching an accident-prone road section in (number of meters). Special attention should be drawn to pedestrians running out onto the road”.

Moreover, if the traffic accidents occurred on the road sections 304-1, 304-2, 304-3, and 304-4 during the time period of interest have led to one or more fatalities and/or injured people, this information may be also indicated to the driver of the car 302 to motivate him/her to be even more careful on these road sections.

When the car 302 passes through the end point of each of the road sections 304-1, 304-2, 304-3, and 304-4, the apparatus 100 may inform the driver that the corresponding accident-prone road section is over. For example, this may be done by using a certain visual indicator (e.g., it may be “red” when the car 302 is at the threshold distance from or within the accident-prone road section and “green” when the car 302 is outside any accident-prone road section, i.e., has passed its end point).

It should be noted that each step or operation of the method 200, or any combinations of the steps or operations, can be implemented by various means, such as hardware, firmware, and/or software. As an example, one or more of the steps or operations described above can be embodied by processor executable instructions, data structures, program modules, and other suitable data representations. Furthermore, the processor-executable instructions which embody the steps or operations described above can be stored on a corresponding data carrier and executed by the processing unit 102. This data carrier can be implemented as any computer-readable storage medium configured to be readable by said at least one processor to execute the processor executable instructions. Such computer-readable storage media can include both volatile and nonvolatile media, removable and non-removable media. By way of example, and not limitation, the computer-readable media comprise media implemented in any method or technology suitable for storing information. In more detail, the practical examples of the computer-readable media include, but are not limited to information-delivery media, RAM, ROM, EEPROM, flash memory or other memory technology, CD-ROM, digital versatile discs (DVD), holographic media or other optical disc storage, magnetic tape, magnetic cassettes, magnetic disk storage, and other magnetic storage devices.

Although the exemplary embodiments of the present disclosure are described herein, it should be noted that any various changes and modifications could be made in the embodiments of the present disclosure, without departing from the scope of legal protection which is defined by the appended claims. In the appended claims, the word “comprising” does not exclude other elements or operations, and the indefinite article “a” or “an” does not exclude a plurality. The mere fact that certain measures are recited in mutually different dependent claims does not indicate that a combination of these measures cannot be used to advantage.

What is claimed is:

1. An apparatus for warning a driver about an accident-prone road section, comprising:
a memory unit configured to store:
geographical coordinates of boundaries of each of at least one accident-prone road section within a geographical area of interest, each of the at least one accident-prone road section being a road section where at least two traffic accidents have occurred during a time period of interest; and
accident-related data for each of the at least two traffic accidents occurred on each of the at least one accident-prone road section during the time period of interest;
a processing unit coupled to the memory unit and configured to:
receive geographical coordinates of a moving vehicle of the driver;
based on the geographical coordinates of the moving vehicle and the geographical coordinates of boundaries of each of the at least one accident-prone road section, determine an approaching accident-prone road section from among the at least one accident-prone road section; and
when a distance between the moving vehicle and the approaching accident-prong road section is equal to a threshold distance, generate a warning signal for the driver, the warning signal comprising information about the approaching accident-prone road section that is defined based on the accident-related data for each of the at least two traffic accidents occurred on the approaching accident-prone road section for the time period of interest; and
an output unit coupled to the processing unit and configured to output the warning signal to the driver.

2. The apparatus of claim 1, wherein the accident-related data comprises at least one of:
a total number of traffic accidents occurred on each of the at least one accident-prone road section for the time period of interest;
a type of each of the at least two traffic accidents occurred on each of the at least one accident-prone road section;
a cause of each of the at least two traffic accidents occurred on each of the at least one accident-prone road section;
consequences of each of the at least two traffic accidents occurred on each of the at least one accident-prone road section, and
road conditions observed during each of the at least two traffic accidents occurred on each of the at least one accident-prone road section.

3. The apparatus of claim 2, wherein the type of each of the at least two traffic accidents occurred on each of the at least one accident-prone road section comprises at least one of:
a collision with one or more pedestrians;
a collision with one or more animals;
a collision with one or more obstacles;
a collision between two or more vehicles;
a rollover of one or more vehicles.

4. The apparatus of claim 2, wherein the cause of each of the at least two traffic accidents occurred on each of the at least one accident-prone road section comprises at least one of:
speeding;
driver inattention;
a pedestrian crossing a road in an inappropriate place;
a violation of rules of crossing an intersection;
driving under a prohibited traffic light sign;
an animal running out onto a road; and
a driver failed to control a vehicle.

5. The apparatus of claim 2, wherein the consequences of each of the at least two traffic accidents occurred on each of the at least one accident-prone road section comprise at least one of:
a number of fatalities;
a number of injured people; and
a level of property damage.

6. The apparatus of claim 2, wherein the road conditions observed during each of the at least two traffic accidents occurred on each of the at least one accident-prone road section comprise at least one of:
a type of an atmospheric phenomenon;
a condition of a road surface;
an ambient temperature;
a time of day;
a week day; and
lighting conditions.

7. The apparatus of claim 5, wherein the processing unit is configured, if the consequences for each of the at least two traffic accidents occurred on the approaching accident-prone road section during the time period of interest comprise the number of fatalities and/or the number of injured people, to generate the warning signal such that the warning signal further comprises the number of fatalities and/or the number of injured people.

8. The apparatus of claim 2, wherein the processing unit is further configured to find, among the causes of the at least two traffic accidents occurred on the approaching accident-prone road section during the time period of interest, a common cause that has led to a maximum number of traffic accidents on the approaching accident-prone road section during the time period of interest, and wherein the warning signal further indicates the common cause.

9. The apparatus of claim 2, wherein the processing unit is further configured to:
receive information about current road conditions observed on the approaching accident-prone road section; and
calculate a degree of traffic accident probability for the driver based on the current road conditions and the road conditions observed during each of the at least two traffic accidents occurred on the approaching accident-prone road section for the time period of interest; and
wherein the output unit is further configured to output the degree of traffic accident probability to the driver.

10. A method for warning a driver about an accident-prone road section, comprising:
storing geographical coordinates of boundaries of each of at least one accident-prone road section within a geographical area of interest, each of the at least one accident-prone road section being a road section where at least two traffic accidents have occurred during a time period of interest;
storing accident-related data for each of the at least two traffic accidents occurred on each of the at least one accident-prone road section during the time period of interest;
receiving geographical coordinates of a moving vehicle of the driver;
based on the geographical coordinates of the moving vehicle and the geographical coordinates of boundaries of each of the at least one accident-prone road section, determining an approaching accident-prone road section from among the at least one accident-prone road section; and
when a distance between the moving vehicle and the approaching accident-prong road section is equal to a threshold distance, generating a warning signal for the driver, the warning signal comprising information about the approaching accident-prone road section that is defined based on the accident-related data for each of the at least two traffic accidents occurred on the approaching accident-prone road section for the time period of interest; and
outputting the warning signal to the driver.

11. The method of claim 10, wherein the accident-related data comprises at least one of:
a total number of traffic accidents occurred on each of the at least one accident-prone road section for the time period of interest;
a type of each of the at least two traffic accidents occurred on each of the at least one accident-prone road section;
a cause of each of the at least two traffic accidents occurred on each of the at least one accident-prone road section;
consequences of each of the at least two traffic accidents occurred on each of the at least one accident-prone road section, and
road conditions observed during each of the at least two traffic accidents occurred on each of the at least one accident-prone road section.

12. The method of claim 11, wherein the type of each of the at least two traffic accidents occurred on each of the at least one accident-prone road section comprises at least one of:
a collision with one or more pedestrians;
a collision with one or more animals;
a collision with one or more obstacles;
a collision between two or more vehicles;
a rollover of one or more vehicles.

13. The method of claim 11, wherein the cause of each of the at least two traffic accidents occurred on each of the at least one accident-prone road section comprises at least one of:
speeding;
driver inattention;
a pedestrian crossing a road in an inappropriate place;
a violation of rules of crossing an intersection;
driving under a prohibited traffic light sign;
an animal running out onto a road; and
a driver failed to control a vehicle.

14. The method of claim 11, wherein the consequences of each of the at least two traffic accidents occurred on each of the at least one accident-prone road section comprises at least one of:
a number of fatalities;
a number of injured people; and
a level of property damage.

15. The method of claim 11, wherein the road conditions observed during each of the at least two traffic accidents occurred on each of the at least one accident-prone road section comprise at least one of:
a type of an atmospheric phenomenon;
a condition of a road surface;
an ambient temperature;
a time of day;
a week day; and
lighting conditions.

16. The method of claim 14, wherein, if the consequences for each of the at least two traffic accidents occurred on the approaching accident-prone road section during the time period of interest comprise the number of fatalities and/or the number of injured people, the warning signal further comprises the number of fatalities and/or the number of injured people.

17. The method of claim 11, further comprising finding, among the causes of the at least two traffic accidents occurred on the approaching accident-prone road section during the time period of interest, a common cause that has led a maximum number of traffic accidents on the approaching accident-prone road section during the time period of interest, and wherein the warning signal further indicates the common cause.

18. The method of claim 11, further comprising:
receiving information about current road conditions observed on the approaching accident-prone road section;
calculating a degree of traffic accident probability for the driver based on the current road conditions and the road conditions observed during each of the at least two traffic accidents occurred on the approaching accident-prone road section for the time period of interest; and
outputting the degree of traffic accident probability to the driver.

19. A computer program product comprising a computer-readable storage medium, wherein the computer-readable storage medium stores a computer code which, when executed by at least one processor, causes the at least one processor to perform the method according to claim 10.
